(19) United States
(12) Patent Application Publication
(10) Pub. No.: US 2009/0213414 A1
(43) Pub. Date: Aug. 27, 2009

(54) Printers and Printing

(75) Inventors: Gregory Braverman, Hertzelia (IL); Eyal Shelef, Tel-Aviv (IL); Shlomo Harush, Nes-Ziona (IL); Arnon Elihav, Rehovot (IL); Alon Moshe, Petakh-Tikva (IL); Rachel Lev-Ran, Rehovot (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett Packard Development Company L.P., Houston, TX (US)

(21) Appl. No.: 12/091,454

(22) PCT Filed: Oct. 24, 2005
(86) PCT No.: PCT/US2005/038388

§ 371 Date: Feb. 3, 2009

(51) Int. Cl. G06F 3/12

(52) U.S. Cl. 358/1.15

(57) ABSTRACT

A printer control system (101) comprising a processor (104) and processor accessible memory (103), the processor (104) being adapted to control the memory (103) to store a concordance between substrate identities for different identified substrates and print control data to be used by the print control system (101) in controlling a printer to control colour and/or quality when printing upon identified substrates, the processor (104) being adapted to associate at least one first identified substrate with the same print control data used for a second, different, identified substrate.

### RELATED APPLICATIONS

This patent application claims priority to application PCT/US2005/038388, having title “PRINTERS AND PRINTING”, filed on 24 Oct. 2005, commonly assigned herewith, and hereby incorporated by reference.

### FIELD OF THE INVENTION

The present invention relates generally to printers and printing and, more particularly, although not exclusively, to liquid electrostatic printing and to digital printing primarily, but not exclusively, on a large industrial scale as opposed to low volume office printers.

### BACKGROUND TO THE INVENTION

In order to achieve satisfactory print quality when printing with different substrates, which may themselves be of different colours, or have different ink absorption characteristics, print control software of some known industrial presses or printers keeps track of different colour related printing parameters for each printing substrate, so that the press is calibrated separately for each substrate installed on the press. In the case of a digital printing press, which is capable of working simultaneously with, say, twelve substrates, a calibration procedure for each substrate involves significant time and consumables. If calibration is performed using a high quality (expensive) substrate then this represents a high financial loss. Moreover, the time spent calibrating the imaging apparatus of the press is effectively downtime and so during that time the press is not generating income. These problems are exacerbated in short runs of print (the waste per print is spread over a larger number of useful prints in larger runs).

### SUMMARY OF INVENTION

According to a first aspect of the invention there is provided a printer control system comprising a processor and processor accessible memory, the processor being adapted to control the memory to store a concordance between substrate identities for different identified substrates and print control data to be used by the printer control system in controlling a printer to control colour and/or quality when printing upon identified substrates, the processor being adapted to associate at least one first identified substrate with the same print control data used for a second, different, identified substrate.

According to a second aspect of the invention there is provided a computer processor-implemented method of printing comprising using print control data stored in computer memory to control print conditions of the printer to control print colour and/or quality, the method comprising, for each substrate to be identified as an identified substrate to be printed upon, using appropriate print control data to control the print conditions of the printer printing upon the identified substrate, wherein for at least one identified substrate the print control data used in a printing operation is selected by a computer processor to be the same print control data that is used to control printing upon a different identified substrate.

According to a third aspect of the invention there is provided a printed substrate which has been produced by the method of the second aspect of the invention.

According to a fourth aspect of the invention there is provided a method of printing upon a substrate comprising identifying the substrate to be printed upon to a computer processor as being of a first identity, the computer processor selecting print control data adapted to control the operation of the printer to control colour and/or quality of a printing operation, and the selected print control data being the print control data of a different, second identity of substrate with which said print control data is associated, said first identity of substrate not having its own print control data different from those associated with said second identity of substrate.

According to a fifth aspect of the invention there is provided a data structure for controlling printing operations of a printer comprising a plurality of parent node substrate identities representative of different substrates upon which printing may occur, a concordance between each parent substrate identity and respective print control data to be presented for use in controlling a printing operation when a substrate to be printed upon is identified as being a parent substrate, and at least one child substrate identity comprising a leaf from a said parent node substrate identity, the arrangement being such that when a child substrate identity is selected as being the substrate to be printed upon and the data structure is used to control printing operations of a printer such that the print control data of the associated parent node is available for use in controlling printing upon the substrate.

According to a sixth aspect of the invention there is provided a printer control program product for a printer control system, the program product comprising instructions which, when loaded onto the printer control system, configure a processor of the printer control system to be capable of controlling a memory of said system to store a concordance between substrate identities for different identified substrates, and print control data to be used by the print control system in controlling a printer to control colour and/or quality when printing on identified substrates, the instructions further configuring the processor to associate at least one first identified substrate with the same print control data used for a second, different, identified substrate.

The printer control software may be stored on a machine-readable data carrier including any one or more of the following non-exhaustive list: floppy disk, hard drive, CD-ROM, DVD ROM or RAM (including -R/-RW and +R/+RW), a tape, any form of magneto optical drive, a transmitted signal (eg an Internet download or file transfer, or the like), a wire.

According to a seventh aspect of the invention there is provided a printer control system comprising a means for processing data and means for storing data, the means for processing data being adapted to control the means for storing data to store a concordance between substrate identities for different identified substrates and print control data to be used by the print control system in controlling a printer to control colour and/or quality when printing upon identified substrates, the means for processing data being adapted to associate at least one first identified substrate with the same print control data used for a second, different, identified substrate.

### BRIEF DESCRIPTION OF THE DRAWINGS

Various embodiments of the invention will now be described by way of example only, with reference to the accompanying drawings, in which:

FIG. 1 is a schematic representation of imaging apparatus of a liquid electrostatic printer in accordance with an embodiment of the invention,

FIG. 2 is a more detailed view of part of the imaging apparatus of FIG. 1,

FIG. 3 is a schematic representation of an electrostatic printer in accordance with an embodiment of the invention, including the imaging apparatus of FIG. 1,

FIG. 4 is a first representation of a group of related substrates to exemplify a feature of the invention used in one embodiment,

FIG. 5 is a second representation of the group of related substrates of FIG. 4,

FIG. 5a is another representation of a group of related substrate identities,

FIG. 6 is a screen shot from a graphics user interface of the control system of the printer of FIG. 3,

FIG. 7 is a flow diagram of a process used in an embodiment of the invention showing the steps of adding a substrate to a substrate group, and

FIG. 8 is a flow diagram of a process used in an embodiment of the invention showing the steps of printing a document.

### DETAILED DESCRIPTION OF PREFERRED EMBODIMENTS

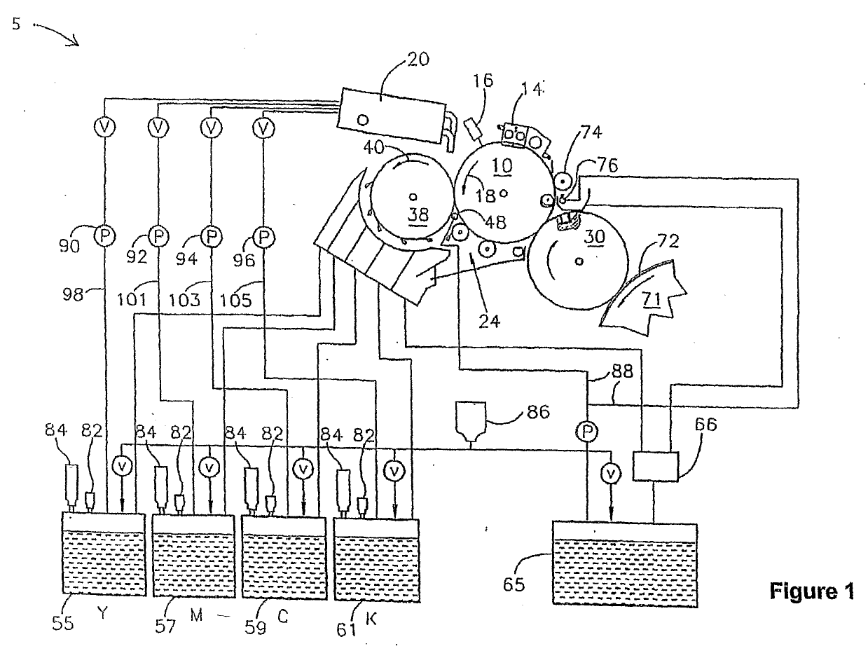

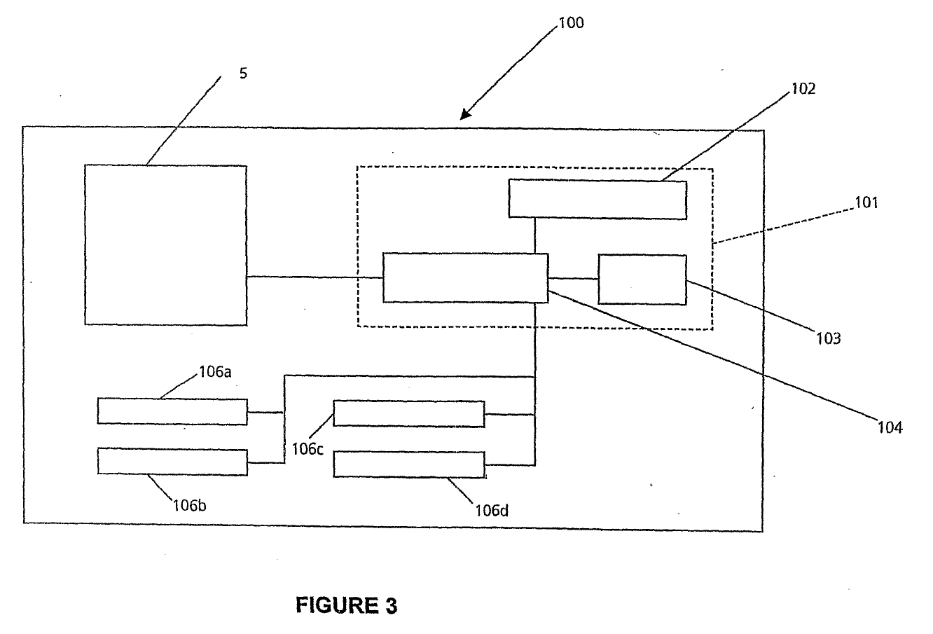

With reference to FIGS. 1, 2 and 3 there is shown an electrostatic printer 100 (hereinafter referred to as the (digital) press) which comprises an imaging system 5, a press control system 101, and substrate feed trays 106a, 106b, 106c, and 106d. Although only four such trays are shown, more or less trays may be provided. The press control system 101 comprises a data processor 104, a memory 103 and a user input/output arrangement 102. The user input/output arrangement provides a Graphic User Interface (GUI) on a display (not shown) and the user is able to manipulate the GUI with input keys/buttons (not shown). It may be that the press control system 101 is controlled by an external computer (eg by a PC which is connected to the press in addition to or instead of the input/output arrangement 102). Alternatively, it may be that the press control system 101 is remote from the press and is linked/connected thereto by way of a control connection.

In response to instructions from the data processor 104 the operation of the imaging system 5 is controlled to print on any of the substrates stored in one or more of the trays 106a, 106b, 106c, and 106d, which substrates are conveyed from their respective trays to the imaging system 5 by a substrate conveying assembly (not illustrated). The imaging system 5 then prints on the substrates so conveyed.

The trays 106a-106d preferably each hold a different substrate type which is available to be printed on by the imaging system 5. Each substrate type is of differing dimensions and/or has different physical properties (for example colour, ink absorbency, transparency and weight) as compared to the substrates in other trays. For example, one tray may hold paper of a particular size and colour, another tray may hold matt substrate of a particular size, another tray may hold glossy substrate of a particular size. Typical substrates include, but are not limited to, sheet materials such as paper, card, poster-board, textiles, Mylar®, plastic sheet and transparencies, for example.

As will be described in more detail below, print control data, comprising colour calibration parameters (or printing settings), control the imaging system 5 to control print colour and/or quality, and is dependent on which substrate type it is required to print on. A calibration process therefore needs to be performed to determine the colour calibration parameters for a particular substrate type. The colour calibration parameters are then stored in the memory 103.

Two extreme approaches could be taken to calibrating a digital printer, or press, for use with different substrates.

The first approach that may be considered is that each substrate is calibrated individually and all relevant process parameters are saved in memory for each substrate. This provides a high/good print quality. A major disadvantage, however, is that in this case press utilisation is low and waste is high due to frequent colour calibrations. As an example, it is necessary to re-calibrate and perform a test print on a new substrate every time that the substrate is changed, and it may be necessary to check the calibration at regular intervals, even if only one substrate is used.

An alternative approach that may be considered is to calibrate the press on one substrate alone and use calibration parameters of that substrate for all substrates, ignoring their slightly different colours and/or ink acceptance characteristics. This will result in the quality for some or all of the substrates (that are not the calibrated substrate) being compromised, and may result in a print quality that is unacceptably low.

Neither of the above approaches is particularly satisfactory.

We have realised that it would be desirable to allow a press user the flexibility to achieve a desired balance between waste of time, and consumables, and print quality.

In the embodiment of FIGS. 1 to 3 a user of the press 100 may wish to print, for example, twenty thousand copies of an image on a particular substrate (eg A4 paper of weight 100 gsm). The user may have data representative of the image stored on a data carrier, such as an optical disc. The data carrier is loaded onto a suitable part of the press 100, or onto a port of a reader device connected/available to the press, and so the image is made available to the imaging system 5. The user uses the input/output arrangement 102 to identify the substrate type that will be used for printing upon (for example A4, 100 gsm) and to enter the number of copies required. A calibration process may then be performed on one or more of the chosen substrates to determine the appropriate colour calibration parameters (or printing settings), and those parameters are then stored in the memory 103 for use when the imaging system begins printing onto the substrate to produce the required number of copies.

The calibration process typically involves telling the press to print a test sample onto the chosen calibration substrate, using pre-defined printing settings (eg laser power, developed voltage, target optical density). The test sample is then inspected by a machine (eg a colour densitometer) and the results obtained checked against the desired results. If the results are not acceptable changes to the printing settings are made and another test sample is printed using the new settings and checked with the print-checking machine. This iterative loop continues until the desired print quality/results are achieved, and the printing settings that achieved that good result are stored in memory as the calibration print settings for that identified substrate.

The colour densitometer, or other test sample checking device, may comprise a sensor or imager built into the digital press, or a separate machine preferably with a communications link communicating the results of the machine checking the test sample to the control processor of the digital press, so as to enable the control processor of the digital press to modify the print control parameters for a subsequent test sample to be printed using the modified print control parameters (and checked again).

As will be described in more detail hereinafter, the press 100 is advantageously configured such that a plurality of different substrate types forms a group of substrates, and each substrate of the group is assigned the colour calibration parameters of one substrate of the group.

Sometimes it will not be necessary to perform a specific calibration operation for a print run to produce printed articles for a new print job/image. For example, when the substrate is the same as one used recently and the existing print setting calibration parameters can still be considered valid. Or when the substrate is identified to the press as being a different substrate to that for which a calibration operation has recently been performed, but the new substrate is in the same substrate group as a calibration substrate for which a calibration operation has been performed recently enough for the calibration parameter printing settings to be considered valid. That is to say, the press control system 101 may consider the new, different, substrate to need the same calibration parameter printing settings as were established for a ‘parent’, or ‘lead’ substrate of the group to which the new substrate belongs (or indeed where settings exist for just another member of the group). This non-performance of a separate calibration operation has advantages as discussed later, especially when the consequence of using the same printing settings can be reliably predicted to be an acceptable quality print run.

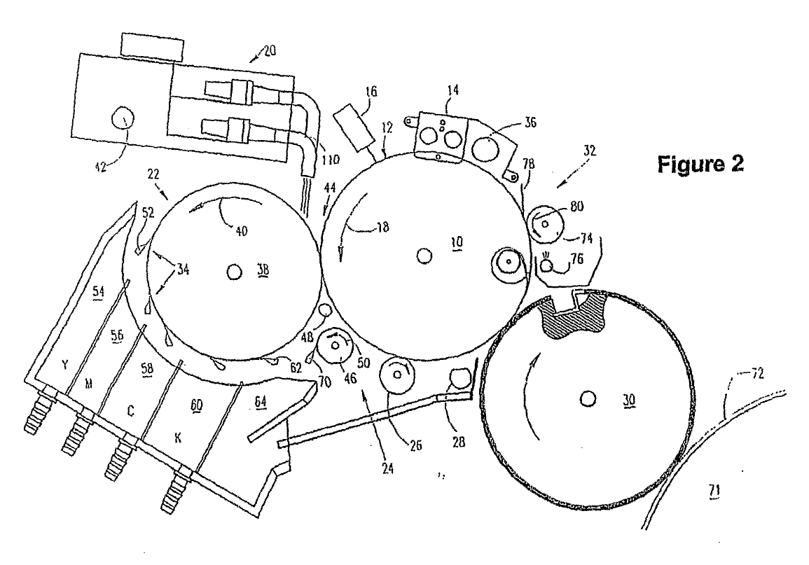

Reference is now made in particular to FIGS. 1 and 2 which illustrate the (multicolour) electrostatic imaging system 5 constructed and operative in accordance with a preferred embodiment of the present invention. As seen in FIGS. 1 and 2 the imaging system 5 comprises an imaging sheet, preferably an organic photoreceptor 12, typically mounted on a rotating drum 10. Photoreceptor sheet 12 may comprise any suitable arrangement of layers of materials as is known in the art. Drum 10 is rotated about its axis by a motor or the like (not shown), in the direction of arrow 18, past charging apparatus 14, preferably a corotron, scorotron or roller charger or other suitable charging apparatus known in the art and which is adapted to charge the surface of sheet photoreceptor 12. The image to be reproduced is focused by an imager 16 upon the charged surface 12 at least partially discharging the photoconductor in the areas struck by light, thereby forming the electrostatic latent image. Thus, the latent image normally includes image areas at a first electrical potential and background areas at another electrical potential.

Imager 16 may comprise a modulated laser beam scanning apparatus, an optical focusing device for imaging a copy on a drum, or other imaging apparatus such as is known in the art.

Also associated with drum 10 and photoreceptor sheet 12 is a multicolour liquid developer spray assembly 20, a developing assembly 22, colour specific cleaning blade assemblies 34, a background cleaning station 24, an electrified squeegee 26, a background discharge device 28, an intermediate transfer member 30, cleaning apparatus 32, and, optionally, a neutralizing lamp assembly 36.

Developing assembly 22 preferably includes a development roller 38. The development roller 38 is preferably spaced from the photoreceptor 12 thereby forming a gap therebetween of typically 40 to 150 micrometers and is charged to an electrical potential intermediate that of the image and background areas of the image. Development roller 38 is thus operative, when maintained at a suitable voltage, to apply an electric field to aid development of the latent electrostatic image.

Development roller 38 typically rotates in the same sense as drum 10 as indicated by arrow 40. This rotation provides for the surface of sheet 12 and development roller 38 to have opposite velocities at the gap between them.

Multicolour liquid developer spray assembly 20, whose operation and structure is described in detail in U.S. Pat. No. 5,117,263, may be mounted on axis 42 to allow assembly 20 to be pivoted in such a manner that a spray of liquid ink containing electrically charged pigmented ink particles can be directed either onto a portion of the development roller 38, a portion of the photoreceptor 12, or directly into a development region 44 between photoreceptor 12 and development roller 38. Alternatively, the developer spray assembly 20 may be fixed to spray in a fixed non-selectable direction. Preferably, the spray is directed onto a portion of the developer roller 38.

Colour specific cleaning blade assemblies 34 are operatively associated with the developer roller 38 for separate removal of residual amounts of each coloured ink remaining thereon after development. Each of the cleaning blade assemblies 34 is selectably brought into operative association with developer roller 38 only when ink of a colour corresponding thereto is supplied to development region 44 by spray assembly 20. The construction and operation of cleaning blade assemblies is described in PCT Publication WO 90/14619 and in U.S. Pat. No. 5,289,238.

Each cleaning blade assembly 34 includes an ink directing member 52 which serves to direct the ink removed by the cleaning blade assemblies 34 from the developer roller 38 to separate collection containers 54, 56, 58, and 60, for each colour to prevent contamination of the various developers by mixing of the colours. The ink collected by the collection containers is recycled to a corresponding ink reservoir (55, 57, 59 and 61). A final ink directing member 62 always engages the developer roller 38 and the ink collected thereat is supplied into collection container 64 and thereafter to reservoir 65 via separator 66 which is operative to separate relatively clean carrier liquid from the various coloured ink particles. The separator 66 may be typically of the type described in U.S. Pat. No. 4,985,732.

The background cleaning station 24, typically including a reverse roller 46 and a fluid spray apparatus 48, is provided for use when the imaging speed is very high. The reverse roller 46 which rotates in a direction indicated by arrow 50 is electrically biased to a potential intermediate that of the image and background areas of photoconductive drum 10, but different from that of the development roller. The reverse roller 46 is preferably spaced apart from photoreceptor sheet 12 thereby forming a gap therebetween which is typically 40 to 150 micrometers.

The fluid spray apparatus 48 receives liquid ink from reservoir 65 via conduit 88 and operates to provide a supply of preferably non-pigmented carrier liquid to the gap between sheet 12 and reverse roller 46. The liquid supplied by fluid spray apparatus 48 replaces the liquid removed from drum 10 by the development assembly 22 thus allowing the reverse roller 46 to remove charged pigmented ink particles by electrophoresis from the background areas of the latent image. Excess fluid is removed from the reverse roller 46 by a liquid directing member 70 which continuously engages reverse roller 46 to collect excess liquid containing ink particles of various colours which is in turn supplied to reservoir 65 via the collection container 64 and separator 66.

The apparatus with components 46, 48, 50 and 70 is not required for low speed systems, but is preferably included in high speed systems.

The electrically biased squeegee roller 26 is urged against the surface of sheet 12 and is operative to remove liquid carrier from the background regions and to compact the image and remove liquid carrier therefrom in the image regions. Squeegee roller 26 is preferably formed of resilient slightly conductive polymeric material as is well known in the art, and is preferably charged to a potential of several hundred to a few thousand volts with the same polarity as the polarity of the charge on the ink particles. The squeegee roller is made by moulding a soft polyurethane rubber coating onto a metal core, coating the moulded core with a conductive lacquer and coating the lacquer with a low conductivity elastomer. Alternatively, in an alternative embodiment, the moulded coating can be made of an elastomer with a controlled conductivity and the lacquer can be omitted. In a further alternative embodiment, a single coating of controlled conductivity elastomer is used and the outer layer is omitted.

Discharge device 28 is operative to flood the sheet 12 with light which discharges the voltage remaining on sheet 12, mainly to reduce electrical breakdown and improve transfer of the image to intermediate transfer member 30. Operation of such a device in a ‘write black’ system is described in U.S. Pat. No. 5,280,326.

FIGS. 1 and 2 further show that multicolour ink spray assembly 20 receives separate supplies of liquid coloured ink typically from four different reservoirs 55, 57, 59 and 61. Associated with each of reservoirs 55, 57, 59 and 61 are typically provided containers of charge director and concentrated toner material, indicated respectively by reference numerals 82 and 84 as well as a supply of carrier liquid, indicated generally by reference numeral 86.

FIG. 1 shows four different coloured ink reservoirs 55, 57, 59 and 61 typically containing the colours Yellow, Magenta, Cyan and, optionally, Black respectively. Pumps 90, 92, 94 and 96 may be provided along respective supply conduits 98, 101, 103 and 105 for providing a desired amount of pressure to feed the coloured ink to multicolour spray assembly 20.

It will be appreciated however that the present invention is equally applicable to monochrome printers and not only to multicolour printers.

Alternatively, the multicolour ink spray assembly 20, which is preferably a three level spray assembly, receives supplies of coloured ink from up to six different reservoirs (not shown) which allows for custom coloured ink in addition to the standard process colours.

It will be appreciated that other print pigment types may alternatively be employed, including powder toners.

Cleaning apparatus 32 is operative to scrub clean the surface of photoreceptor 12 and preferably includes a cleaning roller 74, a sprayer 76 to spray a non-polar cleaning liquid to assist in the scrubbing process and a wiper blade 78 to complete the cleaning of the photoconductive surface. The cleaning roller 74, which may be formed of any synthetic resin known in the art for this purpose, is driven in the same sense as drum 10 as indicated by arrow 80, such that the surface of the roller scrubs the surface of the photoreceptor. Any residual charge left on the surface of photoreceptor sheet 12 may be removed by flooding the photoconductive surface with light from optional neutralizing lamp assembly 36, which may not be required in practice.

In accordance with a preferred embodiment of the invention, after developing each image in a given colour, the single colour image is transferred to intermediate transfer member 30. Subsequent images in different colours are sequentially transferred in alignment with the previous image onto intermediate transfer member 30. When all of the desired images have been transferred thereto, the complete multi-colour image is transferred from the intermediate transfer member 30 to substrate 72. Impression roller 71 only produces operative engagement between the intermediate transfer member 30 and the substrate 72 when transfer of the composite image to substrate 72 takes place. Alternatively, each single colour image is separately transferred to the substrate via the intermediate transfer member. In this case, the substrate is fed through the machine once for each colour or is held on a platen and contacted with the intermediate transfer member 30 for composite image transfer. Alternatively, the intermediate transfer member is omitted and the developed single colour images are transferred sequentially directly from drum 10 to the substrate 72.

The memory 103 has stored therein control software which allows a user of the press 100 to determine one or more so-called ‘calibration substrates’ and one or more (associated) ‘attached substrates’ as will be described in more detail below. Each calibration substrate and any attached substrates form a substrate group. Where the press is controlled externally some/all of the control software may be installed on an external control computer. Each calibration substrate relates a substrate type on which a colour calibration process has been performed, and each of the attached substrates is another substrate type which may be printed on. The colour calibration parameters of a calibration substrate are stored in the memory 103 such that when it is required to print on either the calibration substrate or any of the attached substrates, the colour calibration parameters of the calibration substrate are used to control the imaging system 5. A calibration substrate may be considered as a ‘parent substrate’ and an attached substrate may be considered as a ‘child substrate’.

The calibration substrates and the attached substrates obey the following rules:
An attached substrate cannot have substrates attached to it;
A calibration substrate can be removed from the press only when its group is empty;
Only calibration substrates are calibrated and can be bypassed for colour control (AML (Automatic Machine LUT), ACA (Automatic Colour Adjustment));
Each group headed by a calibration substrate has a common colour calibration parameters list or set (see below).

The following (non-exhaustive and non-limiting) list of colour calibration parameters will be copied from or linked to the calibration substrate data to the files of the respective attached substrates (after calibration of the calibration substrate has been effected):
Electrode voltage of the developer drum
Developer voltage (which controls the depth of the ink layer on the substrate);
Reverse Roller voltage;
Laser power (which controls dot gain);
Machine look-up tables (LUTs);
Target optical density of solid (ie 100% ink coverage);
Colour adjustment derivatives (which determine, for instance, how much the solid optical density will be increased as developer drum voltage is increased by 1 Volt).

It will be appreciated that the colour calibration parameters controlled by selecting a particular substrate type could be one, or more (any number) of the above, in any combination.

Although it is highly preferred that all of the available colour calibration parameters are common to all substrates of a group, it may be that in one embodiment of the invention all substrates of a group have at least one or some colour calibration parameters which are common to all substrates, however other parameters of one or more of the substrates could be set by the user to be of different respective values. Furthermore, although it is also highly preferred that all of the common calibration data of a group is obtained by a calibration procedure or procedures, in one embodiment the user may be able to manually set/determine one or more of the settings/values of common calibration parameters (or even all of them).

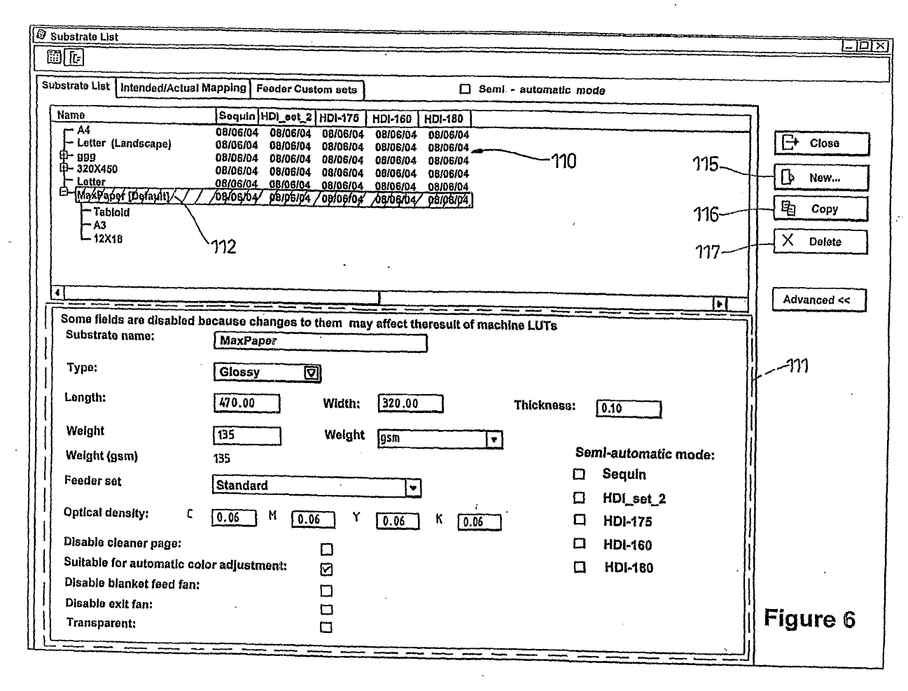

The press 100 is provided with a default substrate list. In a condition in which the settings of the manufacturer (the ‘factory settings’) have not been altered, the default substrate settings will be the factory settings. This substrate list has only a single substrate group (for example, headed by MAXPAPER as shown in FIG. 6). Then, unless previously redefined by a user, the press 100 will set a default calibration to the factory default substrate settings. The default calibration substrate settings can however be changed manually, to be any one of any existing calibration substrates. New, additional, calibration substrates can be added to the press 100.

For each substrate installed on the press (ie for each substrate which is included on the press substrate list, but for which there need not necessarily be a supply of that substrate in one of the feed trays 106a-106d) there is provided a data set which contains the following information (which is not intended to be exhaustive or limiting):
Target optical density;
Colour adjustment and colour match derivatives;
Laser power and developer voltage per screen and ink;
Machine look-up tables for all screens and inks;
Last printed counter (special jobs should not be counted);
List of last colour calibration counters per screen.

If one of the calibration substrates is replaced or depleted (ie the supply of the substrate is low or zero in a respective feed tray 106a-106b), the following pop-up on the GUI of the press control system 101 will be presented to the press operative:

“The calibration substrate Y is depleted or has been replaced. Please ensure that the jobs, which require this calibration substrate will not be calibrated.”

When a new substrate is installed (ie added to the press substrate list), it automatically becomes an attached substrate of the press default calibration substrate, unless it is otherwise allocated or attached to some other calibration substrate (e.g. manually by the user, or automatically by the press, following a calibration test operation).

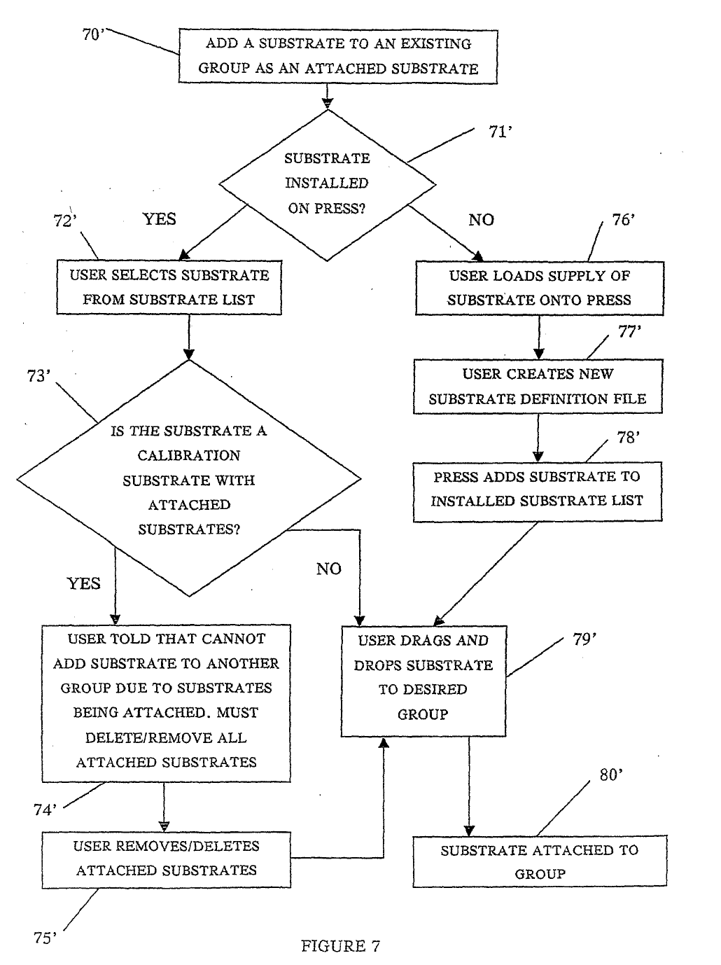

Following on from the explanation above, if a newly installed substrate becomes an attached substrate of the press default calibration substrate, then the colour calibration parameters of the default calibration substrate will be used to control the imaging system 5 to print on the newly installed substrate. FIG. 7, which is described in detail below, shows how a user adds a substrate to a chosen group of substrates.

It is possible to change the status of a substrate in the substrate lists from being an attached substrate to being a calibration substrate. When an attached substrate has its status changed to a calibration substrate by a user, all colour related parameters of its former calibration substrate are copied except for counters and solid optical density. The counters keep track of the number of copies printed on a particular substrate which determine when a calibration procedure is required. The counters of the last calibration substrate are reset. Then before the printing of the first job containing the new calibration substrate, colour calibration will be performed. Solid optical density is set according to the substrate type definition.

A GUI on a screen of the input/output arrangement 102, is shown in FIG. 6, and the GUI displays a press substrate list 110 and substrate definition data 111 of one of the substrates of the press substrate list. The press substrate list shows those substrates which are installed on the press. For each substrate installed on the press 100 substrate definition data is stored in the memory 103. The substrate type MAXPAPER 112 has been selected and the substrate definition data thereof is shown at 111. Substrate defining definition data includes the name of the substrate, the type of substrate (eg glossy or matt), the dimensions of the substrate and the weight of the substrate.

It will be noted that three other substrates are shown as linked or attached to MAXPAPER, namely TABLOID, A3 and 12×18, each of which is a substrate with particular dimensions. The substrate MAXPAPER is the calibration substrate and the substrates TABLOID, A3, 12×18 are the attached substrates. As can be seen from FIG. 6, the three attached substrates are indented from the calibration substrate MAXPAPER. The association of the attached substrates to the calibration substrates is embodied visually by a vertical line (which stems from the text MAXPAPER) and three horizontal (branch) lines which extend therefrom to adjacent the text of each attached substrate. Such a logical representation and/or graphic representation may be termed a ‘substrate tree’.

It is also to be noted that the substrate list 110 includes the calibration substrates ‘A4’, ‘Letter (landscape)’, ‘ggg’ and ‘320×450’ and ‘letter’. Only the substrates ‘ggg’ and ‘320×450’ have attached substrates (as indicated by the ‘+’ expand device). The substrates which are attached to ggg and 320×450 can be viewed by locating a curser of the GUI over the ‘+’ device and the user then providing an input to a curser control device. The entire group is then shown in a similar manner to that for MAXPAPER.

A user is easily able to manipulate/edit/manage the press substrate list 100 and/or one or more of the groups using a mouse (or other curser control device) to control the curser to select the required substrate or group and activate one or more of editing buttons 115, 116, and 117. The button 115 allows a user to install a new substrate to the press substrate list. The button 116 allows a user to make a copy of some or all of the substrate list. The button 117 allows a user to delete one or more substrates from the press substrate list.

By allowing a user the flexibility to alter the contents of the press substrate list, and in particular the contents and/or arrangement of the or each substrate group, the system enables a user to tailor the press control system 101 to meet his varying requirements. For example, it may be that the user requires a higher quality printed product and so whereas one or more substrates were attached substrates a user can arrange those attached substrates to become calibration substrates.

FIG. 5 shows a generalisation of the substrate tree wherein there is shown a calibration substrate with identity Yc and attached substrates with identities Ya(1), Ya(2), Ya(3), through to Ya(n). The substrate tree conveys that Yc is the calibration substrate and that Ya(1) to Ya(n) are the attached substrates.

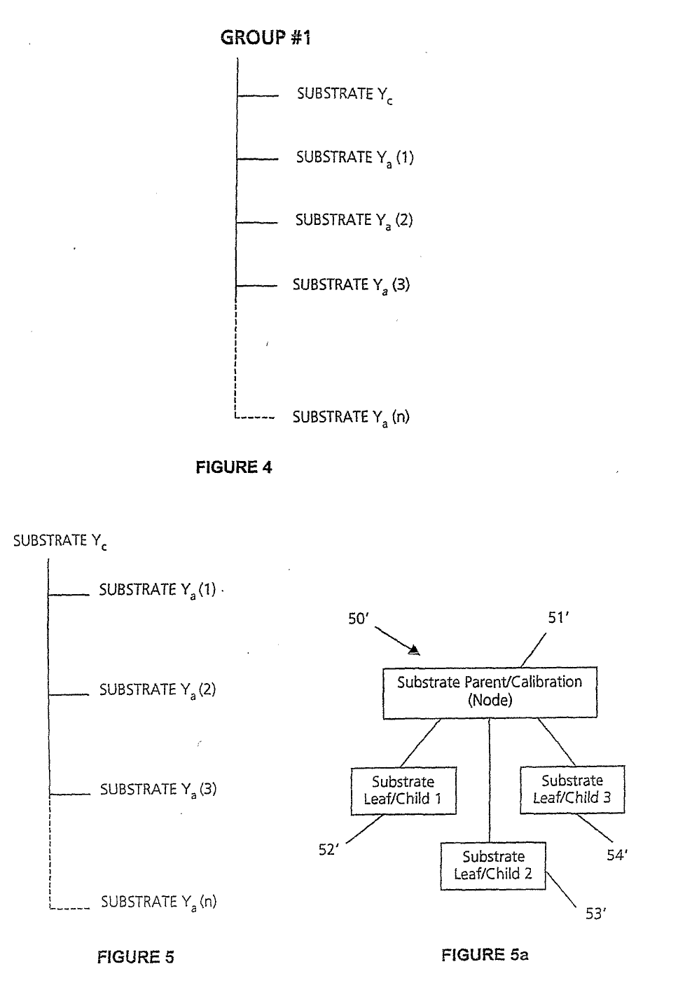

FIG. 4 shows an alternative manner by which substrate groupings could be presented to a user on a GUI. At the top of the substrate tree is the name of group (eg Group#1) which could be assigned by a user or by a machine algorithm. The hierarchical representation makes it clear that the substrate named next to the uppermost branch is the calibration substrate Yc, and that the substrates underneath are attached substrates Ya(1) through to Ya(n). Such a representation would be available for display to the user on the GUI. In a very similar manner to that for the calibration substrate MAXPAPER of FIG. 6, the user may chose to display just the (given) identity of the group (in a contracted condition) or display the group as shown in FIG. 4 (in an expanded condition).

FIG. 5a shows a data structure 50′ in which a parent node 51′ comprises a calibration substrate identity, and leaf, or child, nodes 52′, 53′, 54′, are linked to it. The child/leaf nodes represent identities of substrates which do not have their own separate, different, print control parameters, but instead when a child/leaf substrate is identified as being the substrate upon which printing is to take place the parameters for the parent node 51′ are used. For example, if leaf node 54′ were to be “Xerox paper A4, reference No. 1234”, then when that identity of substrate was typed in to the press as the identity of the substrate, the press would see that it was a child note and use the control parameters of node 51′ for printing operations (the calibration substrate for which the print parameters of node 51′ have been set up could be “Kalamazoo Paper A3, type abcd”—save specified paper.

The identity of a substrate is typically input to the printing press by user when setting up a print run. Some identifying code, or reference, or label, identifying the kind/type of substrate to be printed upon (for example manufacturers reference number for a particular size and weight of paper).

It will be appreciated that there are many ways in which the calibration/attached substrate groups could be presented to a user. It is to be noted that in one embodiment a calibration/attached substrate group may not be represented as such to a user. Rather the substrate grouping is effectively a concept which is internal to the press such that a look-up table (for example) is maintained in the memory 103 of the press in which each installed substrate is associated with a particular set of colour calibration parameters by way of a link to the particular memory location or file in which the relevant colour calibration parameters are stored. It may be that the memory 103 comprises a repository of each set of colour calibration parameters.

FIG. 7 shows a flow diagram of the process of adding a substrate to an existing group as an attached substrate. In the situation that the substrate is already installed on the press (ie it appears on the press substrate list) the user selects from the list the substrate which he wishes to move to another group. It may be that the substrate of interest is a calibration substrate with no attached substrates or that it is an attached substrate.

For example, and with reference to FIG. 6, if a user wishes to add the substrate A4 as an attached substrate to MAXPAPER, the user would use the mouse to locate the curser over the text A4. Using the well-known ‘drag and drop’ technique the user would select A4 and use the mouse to position the curser at or around one of the attached substrates of MAXPAPER. Using the mouse the user would then ‘drop’ the substrate A4 into the list of attached substrates. In so doing the colour calibration parameters of A4 would be replaced as the colour calibration parameters of MAXPAPER. Thereafter the substrate A4 is displayed as an attached substrate of MAXPAPER.

In the situation however where the substrate is a calibration substrate with attached substrates, one embodiment of the invention provides that the GUI of the press 100 will inform the user that before that substrate can be transferred to another group the substrates attached thereto must be deleted/removed. Once that has been performed the user then uses the GUI to ‘drag and drop’ (or cut and paste) the substrate to the desired group.

It may be that as opposed to moving a substrate to an existing group the user wishes to create a new substrate group and use the selected substrate as the calibration substrate. This could be achieved by allowing the user to indicate to the press control system 101 that he wishes to create a new group, of at least a new calibration substrate (which substrate may already appear on the press substrate list as an attached substrate). In one embodiment the user would select a graphic button displayed on the GUI, for example with the text CREATE NEW CALIBRATION SUBSTRATE or CREATE NEW GROUP. The user could then use the mouse (or other curser control device) to select the (attached) substrate from the press substrate list displayed on the GUI. A calibration process would subsequently be performed on the substrate, and its colour calibration parameters stored in the memory 103. To then add attached substrates (from substrates which are on the substrate list) the use employs the ‘drag and drop’ procedure described above.

In the situation where a user wishes to add a substrate to an existing group and the substrate is not already installed on the press, the user is first required to load a supply of the substrate into a tray 106a to 106d of the press 100. Using the GUI of the press 100 the user creates a substrate definition file which includes the substrate definition data for the substrate by selecting the button 115. The substrate definition file may be created by way of the GUI providing a number of data fields, each field being accessible for completion by way of a drop-down menu and/or by way of the user entering the data manually. Once the substrate definition file is created the user is then able to select the substrate on the GUI and place it in a group as an attached substrate.

A user is equally able to remove an attached substrate from a group and remove the substrate entirely from the press. When button 117 is selected the GUI may display a message such as ‘ARE YOU SURE THAT YOU WISH TO REMOVE THE SUBSTRATE FROM THE INSTALLED SUBSTRATE LIST?’ and the user would need to confirm that removal is indeed required. Such a procedure could be effected by using the mouse to select a substrate and then selecting the button 117.

A user could also determine that an attached substrate should be the calibration substrate of the group. In such a scenario the user may decide to make the previous calibration substrate an attached substrate, or remove that substrate from the group altogether. If an attached substrate is ‘promoted’ to be a calibration substrate then a calibration routine will be performed on the substrate and the resulting colour calibration parameters will be stored and used for any future use of the attached substrates of the group by updating the colour calibration data of both the (new) calibration substrate and by updating the colour calibration data of each of the attached substrates. If the previous calibration substrate is made an attached substrate of the group then when it is required to use that substrate for a job the colour calibration parameters of the new calibration substrate will be employed.

It will be noted that calibration operations are only performed on the calibration substrates and not on the attached substrates. As mentioned previously, calibration is performed using a densitometer (or any other suitable device) and usually is performed between jobs and/or at the end of a printing session.

A calibration operation or routine is typically either a short routine (for example ACA) which might take place every two to three hours, or a long routine (for example AML) which might take place once every two days, for each substrate. Although the long routine is more accurate, the short routine wastes less consumables (and less time). The long colour calibration routine performs a full press linearization for each one of installed inks, including calibration of solids. The short calibration calibrates solids and corrects dot gain at fewer points, for example at only single point: e.g. 75% ink coverage for each one of the installed inks. If a new substrate is installed on the press and the substrate is to be a calibration substrate then a long calibration routine may be performed. Calibration control software installed on the press may include various counters such as Total Impression Counter, Last Colour Adjustment Counter, Colour Frequency Counter, for example. Different types of calibration procedures are performed such as colour adjustment calibration and LUT calibration. The calibration control software contains algorithms which can determine, on the basis of the various counter values for each substrate, which calibration routine needs to be performed and on which calibration substrate. The counter values take account of both calibration substrate use as well as use of any attached substrates.

FIG. 7 shows an embodiment of the invention expressed as method steps. A user, such as the manager of a printing press in accordance with any of the previous embodiments of the invention, wants to add a substrate of a particular paper (say paper abc123, obtained from Superpaper Limited) to an existing group of substrates so that the particular substrate assumes the printing parameters of the existing group of substrates. They enter into the printing press, at step 70′, the identity of the paper they want to attach to a substrate group (i.e. type in “Superpaper:abc123”) in order to identify the substrate as being of a specific kind. A control processor on the press checks at step 71′ to see if that substrate/paper already exists in a substrate list of known substrates with associated printing parameters/print control settings.

If the processor determines at step 71′ that the paper type is already known, the processor selects, at step 72′, the known identified substrate from the substrate list and checks at step 73′ whether the substrate is a calibration/parent substrate with at least one attached child substrate. If the processor determines that the substrate is a calibration substrate with at least one child substrate, then at step 74′ the user is told that they cannot add the substrate to another group due to the at least one child substrate attached thereto. The user can then remove/delete the attached substrates at step 75′ if they desire to continue with moving the substrate.

The user is restricted to deleting/removing all of the children substrates from the parent substrate before they are allowed to make the parent substrate a child substrate in another group. This restriction ensures that the printing parameters associated with the group of substrates to which the parent substrate is to be moved, are not inadvertently forced onto the children substrates when the parent is moved. The restriction can also ensure that only one generation of child nodes exist for any one group; a child node cannot also be the parent node to another node.

In other embodiments these restrictions may not apply.

Once the user has removed/deleted any attached substrates, or if the substrate is not a parent substrate with at least one attached substrate, the user drags and drops the substrate to the desired group at step 79′, and the method terminates by the processor attaching the substrate to the desired group at step 80′.

If at step 71′, the processor determines that the substrate is not installed on the press, the user loads a supply of substrate onto the press at step 76′ and creates a new substrate definition file at step 77′. At step 78′ the processor adds the substrate to the installed substrate list.

At step 79′ the user drags the newly added substrate from the installed substrate list to the desired group, and the method terminates by the processor attaching the substrate to the desired group at step 80′.

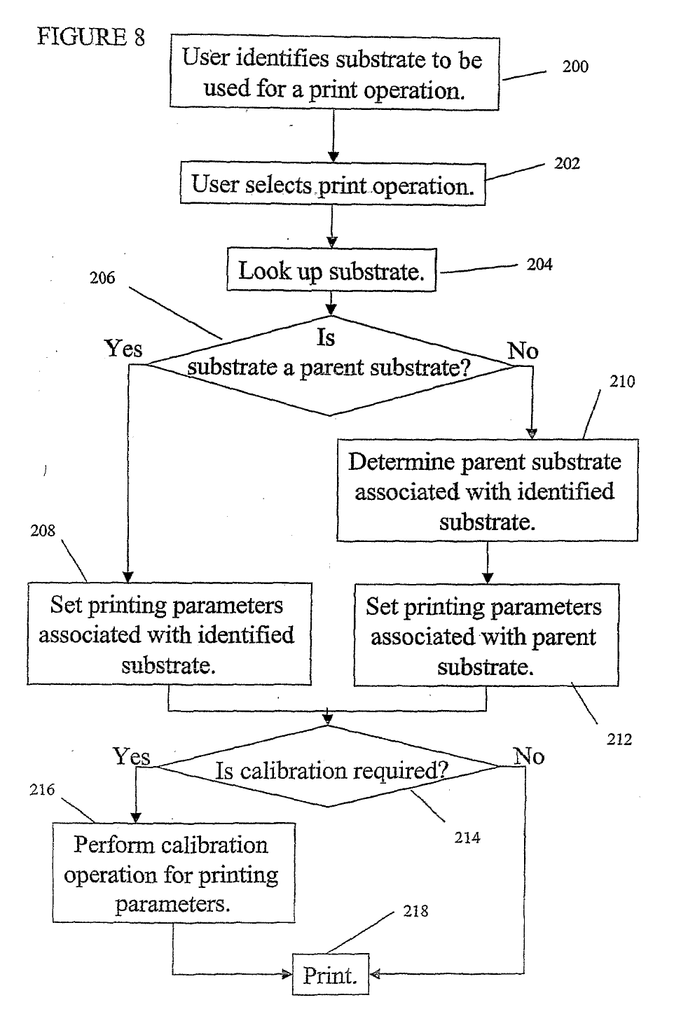

FIG. 8 shows a flow chart of a method for printing a document embodying the present invention. A user, such as the manager of a printing press in accordance with any of the previous embodiments of the invention, wants to perform a print operation (say 10,000 magazine covers) on a particular paper (say paper abc123, obtained from Superpaper Limited). At step 200 the user identifies the substrate on which they desire to perform the print operation. This may involve the user using a mouse or a GUI to select a substrate from a predefined list, or typing in “Superpaper:abc123” for example. In other embodiments the printing system may determine the substrate that is being used in any other way, for example by analysing physical properties of the substrate itself.

At step 202, the user selects a print operation, for example by clicking a “print” button with a mouse or on a GUI, or by physically pressing a print button on the printing press.

The printing system then looks up the substrate on which the print operation is to be performed from a list of substrates that it supports, and determines, at step 206, whether or not the substrate is a parent or a child substrate.

If it is determined that the substrate is a parent substrate, then the method looks up the printing parameters associated with the identified substrate from computer memory (for example, from a database, look-up table, or tree structure) and, at step 208, sets the printing parameters that will be used for the print operation as the printing parameters that are associated with the parent substrate.

If it is determined that the substrate is not a parent substrate (i.e. it is a child substrate), the method determines at step 210 the identity of the parent substrate to which the child substrate belongs. This may involve using a tree structure or look-up table stored in memory to establish an association between the identity of the child substrate and a parent substrate.

The method determines the printing parameters that are associated with the identified parent substrate from computer memory, and sets the printing parameters that will be used for the print operation as the printing parameters that are associated with the parent substrate at step 212.

In other embodiments, the method does not need to determine the identity of the parent substrate; it is only necessary to determine the details of the printing parameters associated with the parent substrate and not the identity of the parent substrate itself. For example, a look-up table may be stored in memory that associates the identity of the child substrate with the memory location of the printing parameters associated with the parent substrate. This allows the printing parameters associated with the parent substrate to be retrieved without the identity of the parent substrate associated with the printing parameters being determined.

After the printing parameters have been set at step 208 or step 212, the method determines whether calibration is required for the selected printing parameters at step 214. This can involve looking at the length of time that has passed since the printing parameters associated with the parent substrate have last been calibrated. If the time that has passed since the last calibration operation is greater than a threshold value, for example more than 2 hours, then the method determines that calibration is required and the method moves on to step 216. If the time is less than the threshold value then the method determines that calibration is not required and the method moves on to step 218 where the print operation is performed. Recalibration is desirable when page to page colour consistency is no longer reliable. Of course, if the printer has a break from printing the threshold will usually be extended. A printing, in use, time of about two hours may be a typical desired time between calibrations.

The threshold time defines a time after which the printing parameters may potentially have drifted from their original, desired, values to an extent that may produce a print operation of an unacceptable quality.

In some embodiments, determining whether or not calibration is required can include looking at the number of print operations and/or number of printed pages that have occurred since the last calibration operation, and comparing these to a threshold value. Typical values for the threshold value of number of printed pages can be of the order of 1000 pages, possibly of the order of one, two or three thousand pages (or more, or less). For CMYK printing a typical threshold number of pages might, for some printers, be 1200 to 1300 pages (say 1250 pages).

In some embodiments, the method can consider the length of time (or number of print operations and/or printed pages) that has passed since any of the family members associated with the parent and child substrate were calibrated as these all use the same printing parameters. If a calibration operation has been performed on a family member recently (as defined by the threshold values discussed above) the method may determine that another calibration operation is not required.

If calibration is not required, the method proceeds to step 218 to perform the print operation.

If it has been determined at step 214 that calibration of the printing parameters is required, the method moves on to step 216. At step 216 the method performs a calibration operation that may involve printing a test page and checking that the quality of the printed test page is acceptable, for example, the colour of the printed test page looks the correct colour, is of an acceptable intensity etc. This may be performed manually by a user, or automatically without user interaction. In some embodiments, the calibration operation may be performed on any substrate within the family associated with the parent and child substrate as they all have the same printing parameters. In some embodiments, the calibration operation may be performed on a substrate within the group that has been identified for this purpose. For example, one of the substrates within the group may be flagged as the substrate that is used for calibration operations, for example the substrate that is the least expensive. In some embodiments the substrate that is used for the calibration operation may be the parent substrate.

After the calibration operation has successfully been performed, the method moves on to step 218, where the print operation is performed.

An advantage of the grouping of substrates as herein described is that, where possible, a calibration substrate is chosen to be a substrate which is less expensive that its attached substrates. Since calibration is only performed on calibration substrates significant cost savings are achieved over performing calibration routines on more expensive substrates. This is because for each substrate test piece (or test sample) on which a calibration process is performed, if the print quality thereof is deemed to be unacceptable (as determined by a densitometer or the like, and/or study by the user) both the ink which was used on the substrate piece and the substrate piece are wasted. If the calibration substrate (eg paper/film) were to cost 5 cents a page, and the test piece was 5 pages, and an attached substrate were to be 2 dollars a page, this can save nearly 10 dollars a calibration operation, in comparison with calibrating on the attached substrate. If this is repeated 10 or 20 times a day, the savings can be significant. Also, the reduction in downtime of the press in not performing a re-calibration when substrates from the same group/tree are used avoids losing production efficiency.

The above-described press 100 has many other important advantages. Because the press allows the user to configure groups to his own requirements he has maximum flexibility. Such flexibility allows the user to create groups for specific jobs (although it will be appreciated that one or more groups of substrates could be required for a single job). For example, one could envisage a substrate group which contains substrates for illustration pages and substrates for cover pages, and both types of substrates are included in the same group. So, both the covers and the illustrations could be printed ‘simultaneously’ by using the same colour calibration parameters for both the cover pages and the illustration pages.

If a job does not require a very high quality product the user may decide to group as many of the substrate types together as possible, whilst respecting to at least some extent the physical characteristics of the various substrate types but at the same time being able to produce a product of an acceptable quality. If a product of a higher quality is required then the user may configure the substrate groups so that the multiple substrates required for the job are divided amongst many more groups in which each group has colour calibration parameters which are better suited to the attached substrates (and thus a better quality product results). It may be that for one or more of the substrates one or more groups consisting only of one substrate (as a calibration substrate) are created and so a printed product of a sufficiently high quality results. In essence, if more substrate groups are used for a job then more calibration substrates are required and more calibration operations. This will provide a higher quality product, but will increase the amount of calibration procedure time/cost involved. With fewer groups fewer calibration substrates are involved, and few calibration operations are performed, and thus fewer substrates need to be calibrated, although the various colour calibration parameters will be less suitable for a greater proportion of the substrates used. As previously mentioned further costs savings are achieved if the calibration substrate is chosen to be the least expensive, or at least less expensive, of/than the other substrates of a group.

A user may decide to group substrates according to physical attributes, for example a group for each colour of substrate, a group for transparent substrates and/or groups based on toner/ink absorbance (eg one for glossy substrates and another for matt substrates).

As the workload of the press operator changes with different customers and different customer requirements, he can reconfigure the press to provide a desired result which strikes a balance between print quality and the waste of consumables, and waste of printing time on calibration operations.

In one embodiment of the invention the press user is able to determine that a first set of colour calibration parameters is to be used to print on one portion of a substrate and that a second set of colour calibration parameters is to be used to print on another portion of that substrate. For example, colour calibration parameters producing a higher print quality could be used for images/pictures as compared to the parameters used to print text on the same substrate. It may be that the first set of parameters is used on one side of the substrate and that the second set is used on the opposite side (either different sides/regions of the same face of a sheet of substrate, or alternatively as opposite faces (sides) of a sheet of substrate (e.g. the front and back of a sheet).

One can design a system in which the press has only a single set of colour related parameters and only a single substrate on which calibration can be performed. Such a system is a good system to reach colour consistency, but not accuracy. This invention is better.

1. A printer control system comprising a processor and processor accessible memory, the processor being adapted to control the memory to store a concordance between substrate identities for different identified substrates and print control data to be used by the print control system in controlling a printer to control colour and/or quality when printing upon identified substrates, the processor being adapted to associate at least one first identified substrate with the same print control data used for a second, different, identified substrate, the processor being configured to be capable of allowing the user to perform at least one of adding, deleting and transferring one or more substrates to/from a first group of associated substrates.

2. A printer control system as claimed in claim 1 in which the processor is configured, in use, to copy the print control data of the second substrate to a memory location relating to the first substrate.

3. A printer control system as claimed in claim 1 in which the processor is configured, in use, to store a link in the memory to the print control data of the second substrate, such that, in use, when the first substrate is to be used the print control data of the second substrate is used.

4. A printer control system as in claim 1 in which the processor is configured to be capable of allowing a user to cause the processor to associate the first identified substrate with print control data of the second identified substrate.

5. A printer control system as in claim 1 in which the processor is configured to be capable of associating the first identified substrate with the print control data of the second identified substrate by way of an automated procedure.

6. A printer control system as claimed in claim 1 in which the processor is adapted to store in the memory the print control data of the second identified substrate as obtained from a calibration procedure performed on said second identified substrate.

7. A printer control system as claimed in claim 1 in which the print control data includes the voltage of a developer drum of the imaging apparatus.

8. A printer control system as in claim 1 in which the print control data includes the electric potential at which a ink substance is maintained.

9. A printer control system as claimed in claim 1 in which the print control data includes at least one of:
(i) the power of an optical system which illuminates an image onto a photo-receptive surface of a developer drum;
(ii) linearization look-up tables;
(iii) colour adjustment derivatives;
(iv) target optical density of solid object;
(v) the voltage of a reverse roller of a background cleaning station;
(vi) colour calibration data for an imaging system of an electrostatic printer;
(vii) an electrostatic voltage used by an electrostatic printer.

10. A method of printing upon a substrate comprising identifying the substrate to be printed upon to a computer processor as being of a first identity, the computer processor selecting print control data adapted to control the operation of the printer to control colour and/or quality of a printing operation, and the selected print control data being the print control data of a different, second identity of substrate with which said print control data is associated, said first identity of substrate not having its own, print control data different from those associated with said second identity of substrate.

11. A printer control program product for a printer control system, the program product comprising instructions which, when loaded onto the printer control system, configure a processor of the printer control system to be capable of controlling a memory of said system to store a concordance between substrate identities for different identified substrates, and print control data to be used by the print control system in controlling a printer to control colour and/or quality when printing on identified substrates, the instructions further configuring the processor to associate at least one first identified substrate with the same print control data used for a second, different, identified substrate, whereby the processor is configured to be capable of allowing the user to perform at least one of adding, deleting and transferring one or more substrates to/from a first group of associated substrates.
